(19) United States
(12) Patent Application Publication
(10) Pub. No.: US 2004/0070973 A1
(43) Pub. Date: Apr. 15, 2004

(54) Lamp decorative base plate structure for compiling textual patterns

(76) Inventor: Han-Ming Lee, Taipei City (TW)

Correspondence Address: HAN-MING LEE, P.O. BOX 7-820, TAIPEI CITY, TW

(21) Appl. No.: 10/270,436

(22) Filed: Oct. 15, 2002

(51) Int. Cl. F21S 13/14

(52) U.S. Cl. 362/252; 362/226; 40/550

(57) ABSTRACT

The present invention relates to a lamp decorative base plate structure for compiling textual patterns, comprising a cover plate, a light bulb, a terminal, and an electric wire, mainly characterized in that the plate integrates with the lamp base as the integral lamp base cover, wherein the cover plate having an embedded hole each on both sides and a latch corresponsive to the cover plates, such that the two bases being assembled in parallel with the electric wire, and two semicircular grooves being disposed on the base plate to form a circle for fixing the electric wire, and the terminal being in a cross position in order to insert into the electric wire for conducting electricity by contact. A hanging ear stand being on a side of the plate body provides a secure positioning such that the light bulb plate parallel to the electric wire cope with the environment to show the compilation of subtitle or intellectual graphics. The present invention has the practical effect for the fun on multiple functions of decorative lamp.

### BACKGROUND OF THE INVENTION

1. Field of the Invention

The present invention relates to a lamp decorative base plate structure for compiling textual patterns, comprising a cover plate, a light bulb, a terminal, and an electric wire, mainly characterized in that the plate integrates with the lamp base as the integral lamp base cover, wherein the cover plate having an embedded hole each on both sides and a latch corresponsive to the cover plates, such that the two bases being assembled in parallel with the electric wire, and two semicircular grooves being disposed on the base plate to form a circle for fixing the electric wire, and the terminal being in a cross position in order to insert into the electric wire for conducting electricity by contact. A hanging ear stand being on a side of the plate body provides a secure positioning such that the light bulb plate parallel to the electric wire cope with the environment to show the compilation of subtitle or intellectual graphics. The present invention has the practical effect for the fun on a multiple functions of decorative lamp.

2. Description of the Prior Art

In the common lamp decorative structures, the structure of the lamp base, light bulb, and electric wire is assembled by the traditional electric wire and electric terminal. The insulating coat of the electric wire is peeled off, and the exposed copper wire is twisted to cope with the electric terminal; such process is laborious, inconvenient, and time-consuming. The modified lamp base has the upper plate and the lower plate for assembling the electric wire device, which has enhanced improvement on the structure over the aforementioned components. However, such modified light bulb is disposed above the electric wire which is arranged and clipped in the base plate. Since the arranged and integrated electric wire cannot be bent and the base plate cannot be secured on the wall by changing its position, therefore its function is limited to the illumination by the light bulb without filly using its functions.

### SUMMARY OF THE INVENTION

The primary objective of the present invention is to provide a lamp decorative base plate structure for compiling textual patterns, particularly the utilization of assembling the base plate, light bulb, terminal, and electric wire to attain the practical effect of showing the fun of multiple functions such as displaying the compiled subtitle or intellectual graphics by means of the application condition that the base plate is parallel to the electric wire.

The secondary objective of the present invention is to provide a lamp decorative base plate structure for compiling textual patterns, in which the plate is integrated with the lamp base to form an integral lamp base cover, and an embedded hole and a latch corresponsive to the cover plate are disposed on each side, such that the two base plates are in parallel with the electric wire.

Another objective of the present invention is to provide a lamp decorative base plate structure for compiling textual patterns, in which two semicircular grooves on the base plate form a circular clip for fixing the electric wire, such that the terminals in cross position are inserted into the electric wire for electric conduction by contact.

Another objective of the present invention is to provide a lamp decorative base plate structure for compiling textual patterns, in which a hanging ear stand on a side of the plate body provides a secure position for compiling the textual patterns.

### BRIEF DESCRIPTION OF THE DRAWINGS

FIG. 1 is a diagram of the assembled lamp base structure of the present invention;

FIG. 2 is an illustrative diagram of the components according to the present invention;

FIG. 3A and FIG. 3B are shows the latching of the embedding components of the present invention;

FIG. 4 is a cross-sectional diagram of the integration of the upper base plates and the lower base with the cover embedded component according to another preferred embodiment of the present invention;

FIG. 5 is an illustrative diagram of the integrated base of the present invention;

FIG. 6 is a diagram showing the effect of displaying the textual patterns for the subtitle according to the present invention.

### DELTAILED DESCRIPTION OF THE PREFERRED EMBODIMENT

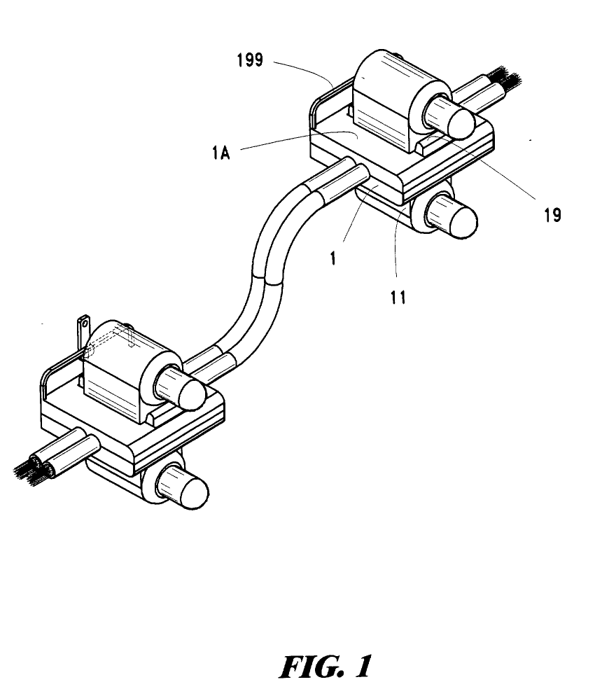

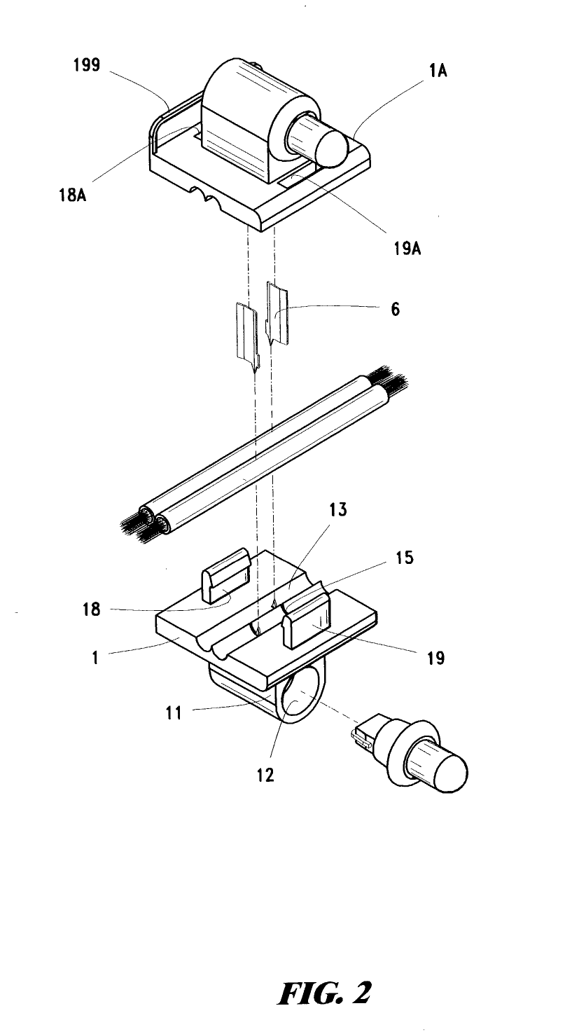

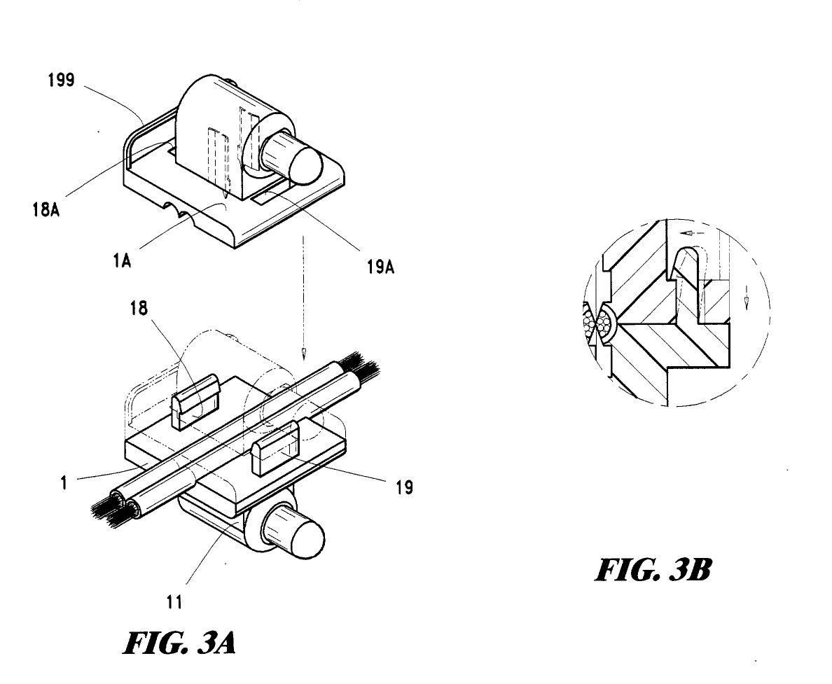

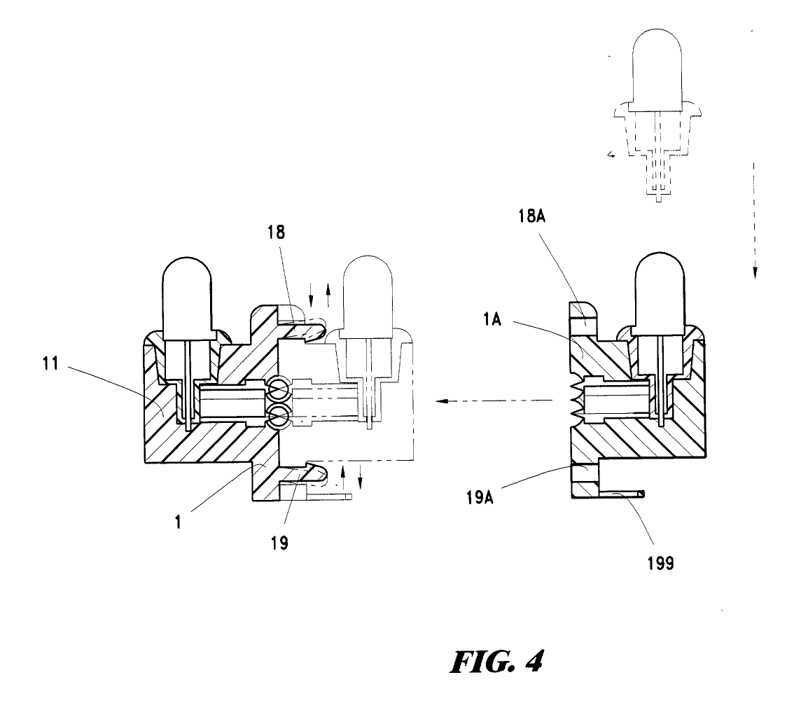

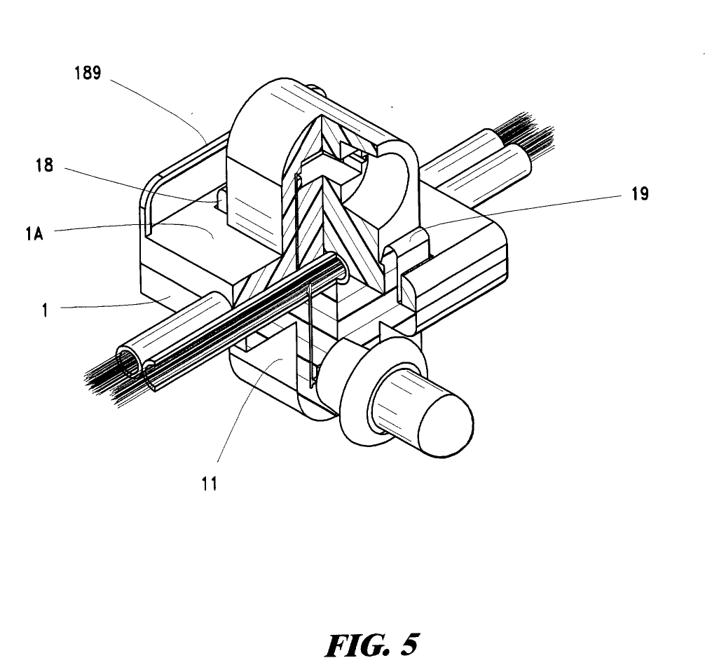

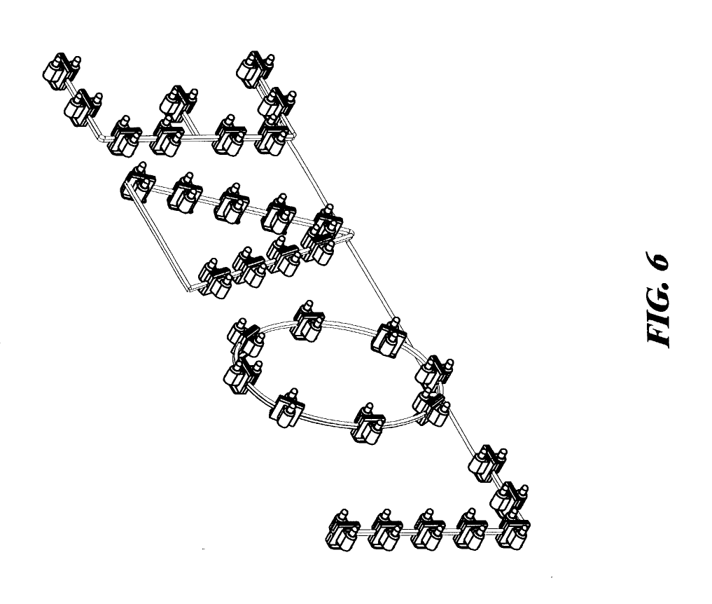

Please refer to FIGS. 1 to 6. The present invention relates to a lamp decorative base plate structure for compiling textual patterns, comprising a cover base plate, a light bulb, a terminal, and an electric wire, wherein a bent lamp base 11 being disposed at the middle section of a lower cover plate 1 forming an integrated lamp base plate, and such lamp base plate having holes 12 for accommodating the plug-in light bulbs, a semicircular groove 13 being disposed at the central section on the surface of the base plate, and a flat hole 15 being disposed at an appropriate position from the groove, such that the end of the terminal plate 6 can pass through the plug-in components into the plate body and straight to the inner side of the hole; a front pin of the terminal plate is inserted through the insulator of the electric wire into the conductive core for lighting up the light bulbs that are plugged into the holes. Two latches 18, 19 are separately disposed each on the sides of the base plate and the end of the two latches has a conical latching member to facilitate the smooth plugging into the embedded hole and form an inverted hooking on the upper cover plate. Such cover plate has an integrated bent lamp base structure at the middle section and a plurality of holes for accommodating the plugging of light bulb, and a semicircular groove at an appropriate position in the middle section for inserting the terminal plate into the flat hole. The surface 1A of the cover plate terminal and the lower plate correspond to the two latching holes 18A, 19A. The upper and lower cover plates have a ringed hanging ear stand 199 on the side to appropriately secure the whole integrated structure in position, such that the two base plates can be integrated plate module which is clipped and parallel with the electric wire. The two semicircular grooves form a circular clip for binding the electric wire in a fixed position, such that the terminals are in a cross position and inserted into electric wire for electric conduction by contact. Such arrangement makes the light bulb plate parallel to the electric wire to show the compilation of subtitle or intellectual graphics, and attains the practical effect for the fun on the multiple functions of decorative lamp.

While the invention has been described by means of specific embodiments, numerous modifications and variations could be made thereto by those skilled in the art without departing from the scope and spirit of the invention set forth in the claims.

What is claimed is:

1. A lamp decorative base plate structure for compiling textual patterns, comprising:
a lower plate, having a bent member at the middle section to be integrated with the base of a lamp base, such integrated base further comprising a hole for accommodating a plug-in light bulb; a semicircular groove at the middle section on the surface of the base plate for accommodating an electric wire; a flat hole being disposed at an appropriate position from the groove, such that the end of the terminal plate passing through the plug-in components into the plate body and straight into the inner side of the hole; two latches being disposed on both sides of the base plate and the end of the two latches having a conical latching member; and
an upper plate corresponsive to the lower plate, having a bent lamp base integrated member at its middle section; a hole for accommodating a plugged-in light bulb; a flat hole at an appropriate position from the semicircular groove at the central section for receiving the insertion of the terminal plate; two embedded holes being disposed on the surface of the base plates, a suspending ringed ear stand being disposed on the sides of the upper and the lower cover plates for securing the position;
such arrangement making the light bulb plate parallel to the electric wire to show the compilation of subtitle or intellectual graphics, and attaining the practical effect for the fun on the multiple functions of decorative lamp.
